(19) United States
(12) Patent Application Publication
(10) Pub. No.: US 2024/0365188 A1
(43) Pub. Date: Oct. 31, 2024

(54) PARALLEL CHANNEL SWITCHING FOR MESH NETWORK

(71) Applicant: HEWLETT PACKARD ENTERPRISE DEVELOPMENT LP, Spring, TX (US)

(72) Inventors: Xuguang Jia, Beijing (CN); Xiaoyang Fu, Beijing (CN); Qiang Zhou, Sunnyvale, CA (US)

(21) Appl. No.: 18/309,425

(22) Filed: Apr. 28, 2023

(51) Int. Cl. H04W 36/06; H04W 48/20; H04W 72/1263

(52) U.S. Cl. CPC H04W 36/06; H04W 48/20; H04W 72/1263; H04W 88/08

(57) ABSTRACT

Implementations of the present disclosure relate to parallel channel switching for mesh network. In the implementations, a first access point (AP) receives a first beacon including an indication of a first channel switch count (CSC) for a first link between the first AP and the second AP from a second AP. The first AP obtains a second CSC for a second link between the first AP and a station. Then, the first AP transmits a second beacon including an indication of the second CSC to the station and within a beacon interval of the second AP upon receipt of the first beacon. In this way, the idle time period for the channel switching procedure of the mesh network can be reduced and minimized, thereby improving the Wi-Fi mesh link stability and reducing the latency.

### BACKGROUND

A channel switch is an attempt to move a basic service set (BSS) to a new operating channel. It is an objective that the disruption to the BSS will be minimized in this process. In order to switch channels, a channel switching announcement (CSA) procedure is performed on an access point (AP) side to announce channel switching to associated stations (STAs) with a Channel Switch Count (CSC). When the CSA procedure is complete, the channel will be switched to a new channel during a specific period which may be referred to as a Max Channel Switch Time (MCST).

The CSA procedure is also introduced in the mesh network. An AP, which may be referred to as a mesh point (MP) in a mesh network, may include a plurality of STA virtual access points (VAPs) connected to corresponding AP VAPs of an uplink MP. The MP may also include a plurality of AP VAPs connected to corresponding STA VAPs of a downlink MP. The STA VAPs and the AP VAPs may usually share the same radio resource. Thus, in the channel switching in the mesh network, the MP needs to follow the CSA procedure of the uplink MP at the STA VAP side and process its own CSA procedure at the AP VAP side thereafter.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with respect to the following figures:

FIG. 1 illustrates an example network environment in which example implementations of the present disclosure may be implemented;

FIG. 2 illustrates an example procedure of parallel channel switching in accordance with some example implementations of the present disclosure;

FIG. 3 illustrates an example procedure of parallel channel switching initiated by an MP in accordance with some example implementations of the present disclosure;

FIG. 4 illustrates an example procedure of parallel channel switching initiated by an MPP in accordance with some example implementations of the present disclosure;

FIG. 5 illustrates an example procedure of traffic allocation during channel switching in accordance with some example implementations of the present disclosure;

FIG. 6 illustrates an example procedure of opportunity sharing during channel switching initiated by an MP in accordance with some example implementations of the present disclosure;

FIG. 7 illustrates a flowchart of an example method of parallel channel switching in accordance with some example implementations of the present disclosure; and

FIG. 8 illustrates a block diagram of an example AP in accordance with some example implementations of the present disclosure.

### DETAILED DESCRIPTION

As discussed above, in a mesh network, a mesh AP is either configured as a mesh portal point (MPP) that uses its wired interface to reach the managed device or an MP that establishes an all-wireless path to the MPP. The MPs locate and associate with their nearest neighbor, which provides the best path to the MPP. The MPP is the gateway between the wireless mesh network and the wired local area network (LAN). The MPP is configured to use its wired interface to establish a link to the wired LAN. The MP is configured to use one of its wireless interfaces to carry traffic and reach the managed device.

During the channel switching procedure in a mesh network, the MPP may initiate the channel switching procedure by transmitting a plurality of beacon frames, each including an information element of a channel switch count (CSC). When the beacon frame, including a CSC of value 1, is transmitted, the MPP switches to a new operating channel. In the mesh network, the STA AP and the AP VAP deployed on the MP usually use the same radio resource, and operate on the same radio frequency bandwidth. In this case, after the STA VAP of the MP follows and completes the CSA procedure of the MPP, the MP may process the CSA procedure of its AP VAP. However, the worst-case scenario is that the CSA procedures are processed sequentially on STA VAPs and AP VAPs one by one.

For a linear mesh topology where the links share the same radio resource, a plurality of CSA procedures along the mesh transmission path may be implemented in a sequential manner on the STA and AP VAPs. The max idle time of such mesh linear topology can be a summation of durations for all the CSA procedures, which may lead to a long idle time period.

Various example implementations of the present disclosure propose a parallel channel switching procedure. In order to achieve parallel processing with CSA procedures for STA VAPs and AP VAPs of an MP, the MP will transmit a beacon to announce the CSA procedure right after the MP receives a beacon indicating channel switching from the MPP. The CSC for the CSA procedure of the MP is selected such that the duration of the CSA procedure for the MP is shorter than the duration of the CSA procedure for the MPP.

With these implementations, the MP will not wait for the CSA procedure for its STA VAP to complete. The CSA procedure for its corresponding STA VAP starts soon after a beacon containing the first CSC is received, and by adjusting a CSC value for the subsequent CSA procedure, the CSA procedure for the AP VAP may end no later than the CSA procedure for the STA VAP of the MP. Therefore, no additional time is used so that the idle time period for the entire CSA procedure performed in the mesh network is reduced, thereby improving the Wi-Fi mesh link stability, and reducing the latency.

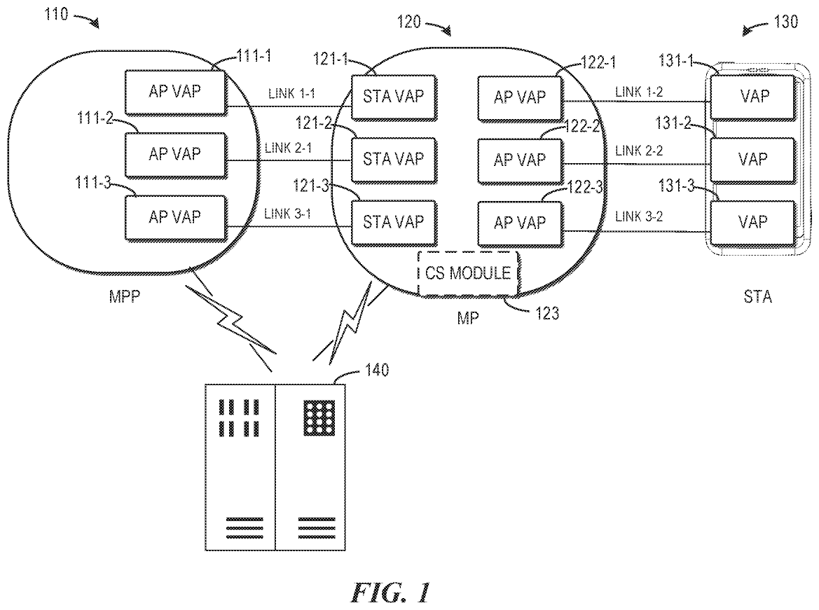

FIG. 1 illustrates an example network environment 100 in which example implementations of the present disclosure may be implemented. As illustrated in FIG. 1, the network environment 100 includes an MPP 110, an MP 120, and an STA 130, as well as a central controller 140. The MPP 110, the MP 120, and the STA 130 are connected in the form of a linear mesh topology. The traffic between the MPP 110 and the STA 130 will be transmitted via the MP 120. The central controller 140 communicates with the MPP 110 and the MP 120, provision the operating parameter of the MPP 110 and the MP 120, and manage the operation action of the MPP 110 and the MP 120. Further, the MPP 110, the MP 120, and the STA 140 all support multi-link operation (MLO) and may be referred to as multi-link devices (MLD).

The MPP 110, the MP 120, and the MP 130 may function according to the IEEE 802.11 family of wireless communication protocol standards, for example, defined by the IEEE 802.11-2016 specification or amendments thereof including, but not limited to, 802.11ah, 802.11ad, 802.11ay, 802.11ax, 802.11az, 802.11ba and 802.11be. These standards define the WLAN radio and baseband protocols for the physical (PHY) and MAC layers.

As illustrated in FIG. 1, the three AP VAPs are deployed on the MPP 110, including an AP VAP 111-1, an AP VAP 111-2, and an AP VAP 111-3. Accordingly, there STA VAPs are deployed on one side of the MP 120, including an STA VAP 121-1, an STA VAP 121-2, and an STA VAP 121-3. The three STA VAPs on the MP 120 are connected with the three AP VAPs on the MPP 110, respectively establishing a link 1-1, a link 2-1, and a link 3-1. In addition, three AP VAPs are deployed on the other side of the MP 120, including AP VAP 122-1, an AP VAP 122-2, and an AP VAP 122-3. At the end of the topology, an STA 130 is connected with the MP 140. Three VAPs 131-1, 131-2, and 131-3 are deployed on the STA 130. Since the STA 130 may only function as a client, the three VAPs on the STA 130 are all STA VAPs. The three VAPs on the STA 130 are connected with the three AP VAPs on the MP 120, respectively establishing a link 1-3, a link 2-3, and a link 3-3.

In the illustrated implementation, the link 1-1 and the link 1-2 share the same radio resource and operate on the same channel, for example, on a 2.4 GHz bandwidth. Similarly, the link 2-1 and the link 2-2 operate on the same channel, for example, on a 5 GHz bandwidth. The link 3-1 and the link 3-2 operate on the same channel, for example, on a 6 GHz bandwidth. If a channel of one link needs to be switched, for example, a channel on which the link 1-1 is operating interfaces with an external channel, all the corresponding links along the linear mesh topology must also be switched to the same new channel. In this case, the link 1-1 and link 1-2 needs to be switched to the same new channel.

In some example implementations, the MPP 110 and the MP 120 may report their operation status to the central controller 140. The central controller 140 may configure channel switching parameters associated with a channel switching procedure of the AP VAP 122-1 of MP 120. For example, the control controller 140 may determine the channel switching parameters for the channel switching procedure of the link 1-2 associated with the AP VAP 122-1 based on the channel switching parameter for the channel switching procedure associated with the STA VAP 121-1. In some alternative implementations, a channel switching module 123 is provided on the MP 120 for managing channel switching actions and provisioning channel switching parameters.

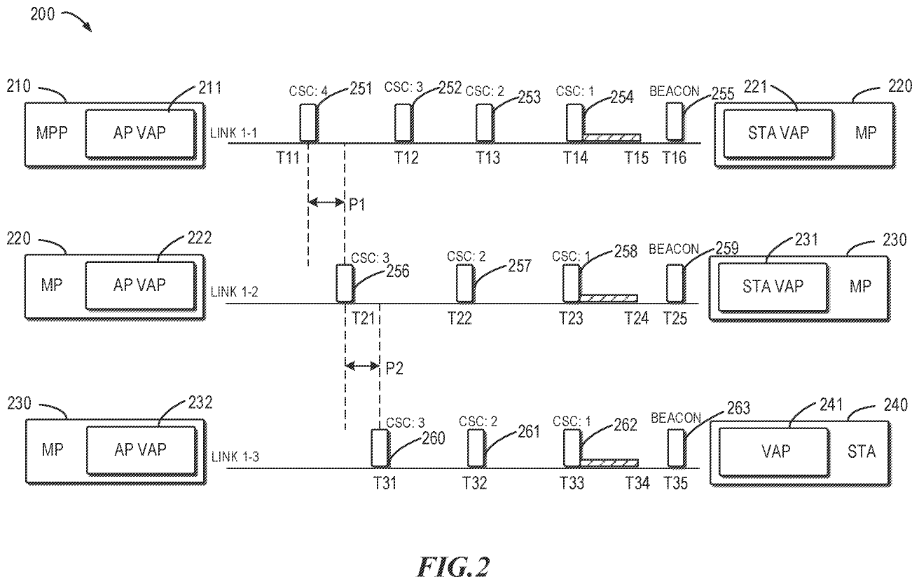

FIG. 2 illustrates an example procedure 200 of parallel channel switching in accordance with some example implementations of the present disclosure. As illustrated in FIG. 2, an MPP 210 includes an AP VAP 211 that connects to an STA VAP 221 deployed on one side of an MP 220. A link 1-1 is established between the AP VAP 211 and the STA VAP 221. The MP 220 further includes an AP VAP 222 that connects to an STA VAP 231 deployed on one side of an MP 230. A link 1-2 is established between the AP VAP 222 and the STA VAP 231. Similarly, the MP 230 further includes an AP VAP 232 that connects to a VAP 241 deployed on an STA 240. A link 1-3 is established between the AP VAP 222 and the VAP 241. The link 1-1, the link 1-2, and the link 1-3 share the same radio resource and operate on the same channel.

At a time point T11, the MPP 210 initiates a CSA procedure by transmitting a beacon frame 251, including an indication of CSC to the MP 220. In the illustrated implementation, the CSC value starts at 4 and indicates that the channel of link 1-1 will be switched to a new channel after another 3 TBTT intervals. Sequentially, the MPP 210 transmits a beacon frame 252 with a CSC value of 3, a beacon frame 253 with a CSC value of 2, and a beacon frame 254 with a CSC value of 1, respectively, at time point T12, T13, and T14. After the MPP 210 transmits the beacon frame 254, the MPP 210 switches to a new channel and completes the channel switching procedure at time point T15. Then, the MPP 210 transmits a beacon frame 255 on the new channel at time point T16.

In some example implementations, for the CSA procedure, the upstream MP may force the STAs in its BSS to stop transmissions until the channel switch takes place by setting the Channel Switch Mode field in the Channel Switch Announcement element to 1. For example, the Channel Switch Mode field in the beacon frame 251 may be 1. In some example implementations, the termination of the transmission may take place after one or more CSC is reduced. For example, the Channel Switch Mode field in the beacon frame 252, 253 may be 1.

During the procedure, when the STA VAP 221 receives the beacon frame 251 at the time point T11, the MP 220 acknowledges that the link 1-2 also needs to be switched. In order to reduce the total max idle time during the CSA procedure for the entire mesh network, a CSA synchronization algorithm is performed to determine channel switching parameters such that the CSA procedure for the link 1-2 may end at the same time or earlier than the time that CSA procedure for the link 1-1 ends.

Mathematically, the max idle time (the maximum time period that the MP AP stops transmissions) for the channel switching procedure of the link 1-1 mainly depends on the channel switching parameters associated with the MPP 210, and the following equation applies:

$${T}_{ma x idle MPP} = ( C {SC}_{M P P} - 1 ) \times T B T {T}_{M P P} + M C S {T}_{M P P} \qquad ( 1 )$$

where T_{maxidle MPP} denotes the maximum idle time; CSC_{MPP} denotes the channel switch count of the MPP 210, the TBTT_{Mpp} denotes the target beacon transmission time of the MPP 210, and MCST_{Mpp} denotes the max channel switch time of the MPP 210.

Similarly, the max idle time for the channel switching procedure of the link 1-2 mainly depends on the channel switching parameters associated with the MP 210 and the following equation applies:

$${T}_{ma x idle MP} = ( C {SC}_{M P} - 1 ) \times T B T {T}_{M P} + M C S {T}_{M P} \qquad ( 2 )$$

where T_{maxidle MP} denotes the maximum idle time; CSC_{MP} denotes the channel switch count of the MP 220, the TBTT_{MP} denotes the target beacon transmission time of the MP 220, and MCST_{Mp} denotes the max channel switch time of the MP 220.

The target that the duration of the channel switching procedure for the link 1-1 is shorter than or equal to the duration of the channel switching procedure for the link 1-2 may be formulated as:

$$( CS {C}_{M P} - 1 ) \times T B T {T}_{M P} + M C S {T}_{M P} \leq ( CS {C}_{M P P} - 1 ) \times T B T {T}_{M P P} + M C S {T}_{M P P} \qquad ( 3 )$$

Since MCST_{MPP} and MCST_{MP} are similar and fixed, they can be omitted. Therefore, the target may be converted to:

$$( CS {C}_{M P} - 1 ) \times T B T {T}_{M P} \leq ( CS {C}_{M P P} - 1 ) \times T B T {T}_{M P P} \qquad ( 4 )$$

In some example implementations, the TBTT_{MP} may be configured such that a first listen time period including a first number of intervals of the TBTT_{MP} IS shorter than or equal to a second listen time period including a second number of intervals of the TBTT_{MPP}. Power management is essential for MLD devices. During the CSA procedure, some of the links may be in the power save mode. In order to guarantee that the MP associated with the MPP is able to successfully listen to a first number of CSCs in beacon/probe respond frames, and the STA associated with the MP is able to listen a second number of CSCs, the following condition needs to be satisfied:

$${N}_{M P} \times T B T {T}_{M P} \leq {N}_{M P P} \times T B T {T}_{M P P} \qquad ( 5 )$$

where N_{Mpp} denotes the first number that the MP needs to listen; TBTT_{MPP} denotes the interval of the TBTT of the MPP; N_{Mp} denotes the second number that the STA needs to listen; TBTT_{Mp} denotes the interval of the TBTT of the MP. For example, in the case that the MPP is configured with a TBTT time having an interval of 200 ms, if N_{MPP}=2, N_{MP}=1, then the MP may be configured with a TBTT interval of 100 ms 200 ms or 400 ms.

After the MPP initiates the CSA procedure, there may still be traffic that needs to be transmitted. Therefore, the buffered downlink traffic from the MPP may cause the link busy for a time period. The time for the MP associated with the MPP to transmit CSA indication may be selected after the busy time period. In this regard, the MP 220 may obtain an indication of a time offset P1 between the time point T11 of receipt of the beacon frame 251 and a time point T21 of transmission of the beacon frame 256. The time offset P1 may be determined by the central access controller or a channel switch module on the MP 220. In this case, the time offset P1 is selected to be greater than or equal to a transmission time period associated with the traffic between the AP VAP 211 of the MPP 210 and the STA VAP 221 of the MP 220, and smaller than or equal to the interval of the TBTT_{MP}. After the time offset P1 is determined, the MP 210 transmits a beacon frame 256 to STA VAP 231 of the MP 230 at the time point T21.

In some example implementations, in the case that TBTT_{MP}≥TBTT_{MPP}, the time offset between the receipt of the indication of the CSC from the MPP and the transmission of the indication of the CSC to the station may satisfy:

$$BU\_TBTT \_offset \leq TBTT\_offset \leq {TBTT}_{M P} \qquad ( 6 )$$

where BU_TBTT_offset denotes the time period to transmit the buffered units stored at the MPP; TBTT_offset denotes the time offset. In some example implementations, the BU_TBTT_offset may be 1 time unit (TU) when the TBTT_{MP} has a value of 100 TUs. In some example implementations, the BU_TBTT_offset may be determined based on the duration of the transmission opportunity gained by the MPP.

In some example implementations to sum up the above, in order to achieve the parallel channel switching in the mesh network, the CSC and TBTT for the MP may be determined according to the following CSA synchronization algorithm:

```
compute CSC_{MP} and TBTT_{MP}
subject to: (CSC_{MP} − 1) × TBTT_{MP} ≤ (CSC_{MPP} − 1) × TBTT_{MPP}
with constraints:
      CSC_{MP} ≥ 1
    N_{MP} × TBTT_{MP} ≤ N_{MPP} × TBTT_{MPP}
  BU_TBTT_offset ≤ TBTT_offset ≤ TBTT_{MP}.
```

Alternatively, the CSC value, the TBTT interval value, and the time offset value may be determined by a channel switching module or a central access controller according to the CSA synchronization algorithm.

For example, the CSC value for the CSA procedure associated with the link 1-2 is 3, the time offset value is P1, and the TBTT interval value is determined such that the duration of the CSA procedure for the link 1-2 is shorter than the duration of the CSA procedure for the link 1-1. Therefore, after MP 220 transmits a beacon frame 256 with a CSC value of 3, a beacon frame 257 with a CSC value of 2, and a beacon frame 258 with a CSC value of 1, respectively, at time point T21, T22, T23, the CSA procedure ends at time point T23 which is no later than T14. Then, the MP 220 switches to the same new channel and completes the channel switch at time point T24. The MP 220 transmits a beacon frame 259 on the new channel at time point T25.

Similarly, when the STA VAP 231 receives the beacon frame 256 at time point T21, the MP 230 acknowledges that the link 1-3 also needs to be switched. The MP 230 may obtain a CSC value, a TBTT interval value, and a time offset value which may be determined according to the CSA synchronization algorithm described above. In this case, the CSC value for the CSA procedure associated with the link 1-3 is also 3, and the time offset value is P2. Further, the TBTT interval value is determined such that the duration of the CSA procedure for the link 1-3 is shorter than the duration of the CSA procedure for the link 1-1. Therefore, after MP 220 transmits a beacon frame 260 with a CSC value of 3, a beacon frame 261 with a CSC value of 2, and a beacon frame 262 with a CSC value of 1 at time point T31, T32, T33, the CSA procedure ends at time point T33 which is no later than T14. After the MP 230 transmits the beacon frame with a CSC of 1, the MP 230 switches to the same new channel and completes the channel switch at time point T34. Then, the MP 230 transmits a beacon frame 263 on the new channel at time point T35.

The channel switching procedure 200 illustrated in FIG. 2 is an example implementation of the CSA parameters obtained according to the CSA synchronization algorithm. With this implementation, the channel switching procedures for respective links end no later than the channel switching procedure initiated by the MPP, thereby minimizing the idle time during the channel switching procedure.

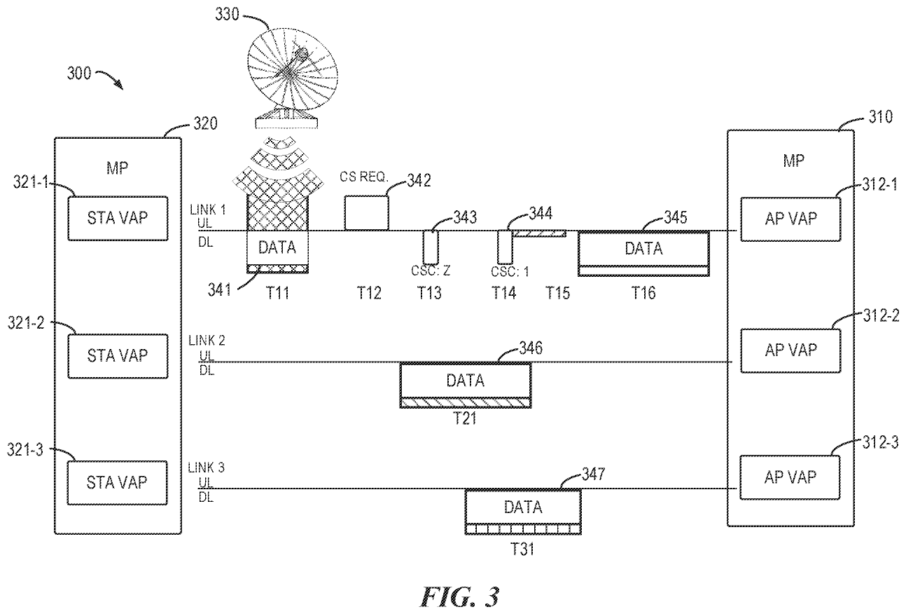

Mesh networks usually include multiple mesh devices. It's challenging to ensure every mesh node can change channels smoothly and does not disconnect. Some traffic management mechanisms are described later with reference to FIGS. 3-6.

As illustrated in FIG. 2, the channel switching procedure is initiated by the MPP. Alternatively, the channel switching procedure may also be initiated by the MP. For example, in the linear mesh topology, as illustrated in FIG. 1, the MP 120 may detect an external signal on a channel. On this basis, the MP 120 determines that the channel is the same as the channel of the link 1-2. The external signal may be transmitted, for example, from a radar system. Therefore, the MP 120 may determine to switch to a clear channel according to the protocol. In order to switch to a new channel, the MP120 transmits a channel switch request to the MPP 110. Upon receiving the channel switch request, the MPP 110 may determine a clear channel or a non-DFS channel as a new channel and initiate the CSA procedure. A parallel channel switching may be then implemented.

However, when an AP detects a radar signal, the AP may be requested to keep silent on the current channel after 20 ms. During this period, if one of the mesh nodes misses the notification frame or has not received a beacon frame for a CSA procedure, the traffic associated with this mesh node may be interrupted. In this regard, a traffic termination mechanism will be described with reference to FIG. 3.

FIG. 3 illustrates an example procedure 300 of parallel channel switching initiated by an MP in accordance with some example implementations of the present disclosure. As illustrated in FIG. 3, the MP 310 is provisioned with three AP VAPs, including an AP VAP 312-1, an AP VAP 312-2, and an AP VAP 312-3. Accordingly, a downstream MP 320 is provisioned with 3 STA VAPs, including an STA VAP 321-1, an STA VAP 321-2, and an STA VAP 321-3. A link 1 is established between the AP VAP 312-1 and the STA VAP 321-1. A link 2 is established between the AP VAP 312-2 and the STA VAP 321-2. A link 3 is established between the AP VAP 312-3 and the STA VAP 321-3.

The link 1 may be operating on a 5 GHz channel. When the MP 310 transmits data to the MP 320 on the link 1, the MP 320 may detect an external signal from a radar system 330. The MP 320 determines to switch the link 1 to a new channel and transmits a channel switch request frame 342 to MP 310 at time point T12. The channel switch request frame 342 contains one flag to indicate the MP 310 to stop sending the downlink frame to MP 320. Therefore, the DL data from the MP 310 will not be missed in case that the MP 320 is requested to keep silent.

After the MP 310 relays the channel switch request frame 342 to the MPP in the mesh network, the MP 310 may receive a channel switching indication and start a CSA procedure for link 1. The MP 310 transmits a beacon frame 343 with a CSC value of Z at time point T13. When the MP 310 transmits a last beacon frame 344 with a CSC value of 1 at time point T14, the MP 310 switches the link 1 to a new channel and completes the switching at time point T15.

During the time period after the channel switching request is transmitted and until the channel switching is complete, the link 2 and the link 3 are still active, and the DL traffic from the MP 310 may be allocated to the link 2 and the link 3 by link mapping negotiation. As a result, a data frame 346 is transmitted at T21 from the AP VAP 312-2 to the STA VAP 321-2, and a data frame 347 is transmitted at T31 from the AP VAP 312-3 to the STA VAP 321-3. After the channel switching procedure is complete, the traffic may be reallocated to link 1. As such, a data frame 345 is transmitted from the AP VAP 312-1 to the STA VAP 321-1 at the time point T16.

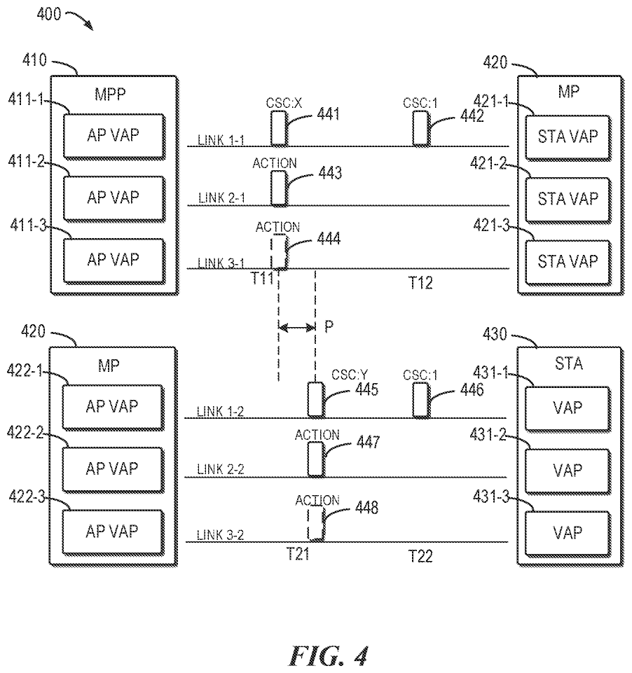

FIG. 4 illustrates an example procedure 400 of parallel channel switching initiated by an MPP in accordance with some example implementations of the present disclosure. In FIG. 4, an MPP 410, an MP 420, and an STA 430 are illustrated. The MPP 410 and the MP 420 are connected in the form of a mesh topology.

Three AP VAPs are deployed on the MPP 410, including an AP VAP 411-1, an AP VAP 411-2, and an AP VAP 411-3. Accordingly, three STA VAPs are deployed on one side of the MP 420, including an STA VAP 421-1, an STA VAP 421-2, and an STA VAP 421-3. The three STA VAPs on the MP 420 are connected with the three AP VAPs on the MPP 410 respectively establishing a link 1-1, a link 2-1, and a link 3-1. In addition, three AP VAPs are deployed on the other side of the MP 420, including AP VAP 422-1, an AP VAP 422-2, and an AP VAP 422-3. Similarly, three VAPs are deployed on the STA 430. Since the STA 430 may only function as a client, the three VAPs on the STA 430 are all STA VAPs. The three VAPs on the STA 430 are connected with the three AP VAPs on the MP 420 respectively establishing a link 1-2, a link 2-2, and a link 3-2. The link 1-1 and the link 1-2 share the same radio resource and operate on the same channel.

When the MPP 410 initiates a CSA procedure and transmits a beacon frame with a CSC value of X at time point T11. In the meantime, the MPP 410 copies the parameters for the CSA procedure in an action frame 443 or an action frame 444 and transmits the action frame 443 on link 2-1 or transmits the action frame 444 on the link 3-1 at time point T21. In some example implementations, the action frame 443 may comprise a CSC value, a new channel number, and a maximum channel switch time. When MP 420 receives the action frame 443 on link 2-1, the MP 420 may determine the parameters for sequential CSA procedures according to the CSA synchronization algorithm described above. For example, the MP 420 may determine a CSC value Y, a time offset P, and a TBTT interval. The MP 420 transmits a beacon frame 445 with a CSC value of Y at time point T21. In the meantime, the MP 420 may also copy the parameters for the CSA procedure in a further action frame 447 or a further action frame 448 and transmit the action frame 447 on the link 2-1 or transmit the action frame 448 on the link 3-1 at time point T21. The action frame 447 or the action frame 448 may comprise the CSA parameters for the link 1-2 and/or the CSA parameters for the link 1-1.

With this implementation, the downstream MPs may be able to receive the new channel number and CSC values from active links via action frames to obtain essential information, which may facilitate the establishment of new links, and thereby avoiding rescanning all channels for the link that needs to be switched.

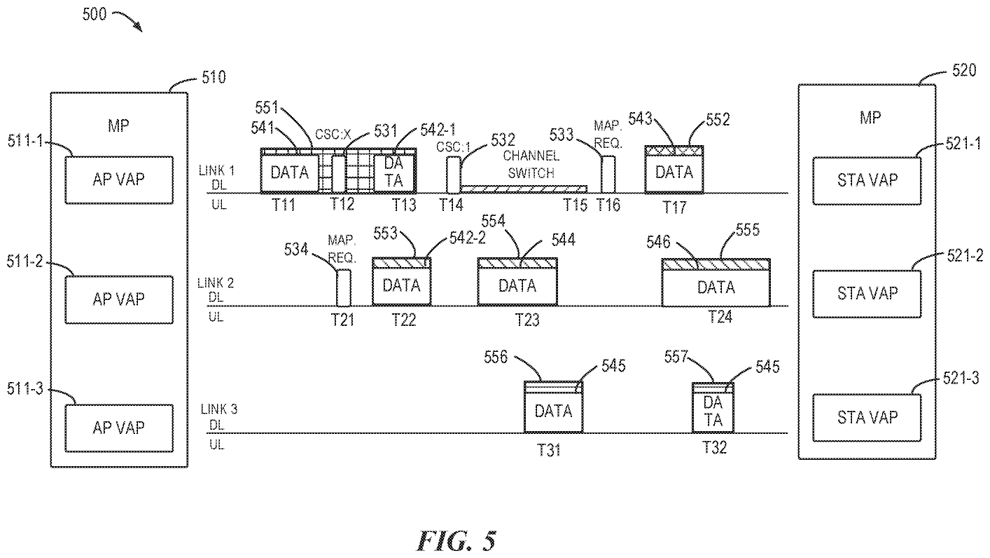

FIG. 5 illustrates an example procedure 500 of traffic allocation during channel switching in accordance with some example implementations of the present disclosure. As illustrated in FIG. 5, the MP 510 is provisioned with three AP VAPs, including an AP VAP 511-1, an AP VAP 511-2, and an AP VAP 511-3. Accordingly, a downstream MP 520 is provisioned with three STA VAPs, including an STA VAP 521-1, an STA VAP 521-2, and an STA VAP 521-3. A link 1 is established between the AP VAP 511-1 and the STA VAP 521-1. A link 2 is established between the AP VAP 511-2 and the STA VAP 521-2. A link 3 is established between the AP VAP 511-3 and the STA VAP 521-3.

In the illustrated implementation, the MP 510 gains an opportunity 551 and transmits data frame 541 at time point T11 within the transmission opportunity (TXOP) 551. However, at time point T12, the MP 510 determines that the link 1 needs to be switched and transmits a beacon frame 531 with a CSC value of X to indicate a channel switching procedure. After the beacon frame 531 is transmitted, the AP VAP 511-2 transmits a traffic identifier (TID)-to-link mapping request frame 534 to the MP 520 at time point T21. The MP 510 and the MP 520 may negotiate a new TID-to-link mapping and allocate the traffic originally mapped to the link 1 to the other active links.

In some example implementations, the traffic, which is originally mapped to the link 1, may be re-mapped to both the link 1 and the link 2 before the channel switches. As illustrated, one part 542-1 of the data frame 542 is transmitted at time point T13 within the TXOP 551, and the other part 542-2 of the data frame 542 is transmitted on the link 2 at time point T22 within the TXOP 553. With these implementations, the traffic can be transmitted before channel switches, thereby avoiding traffic transmission delay.

In some alternative implementations, the traffic, which is originally mapped to the link 1, may be re-mapped to the link 2 and/or the link 3 during the channel switching. As illustrated, during the channel switching, the link 2 and the link 3 are active, and a data frame 544 is transmitted on the link 2 at time point T23 within the TXOP 554, and the data frame 545 is transmitted on the link 3 at time point T31 within the TXOP 556. After the channel switch for the link 1 is complete at time point T15, the AP VAP 511-1 transmits a TID-to-link mapping request at the time point T16 to negotiate a new mapping to recover the traffic on the new link 1. After the negotiation, the data frame 543 is transmitted on the new link 1 at time point T17 within TXOP 552, the data frame 546 is transmitted on the link 2 at time point T24 within TXOP 555, and the data frame 545 is transmitted on the link 3 at time point T32 within TXOP 557. With these implementations, the active links established between MLD devices can be flexibly used for traffic management during a channel switching procedure.

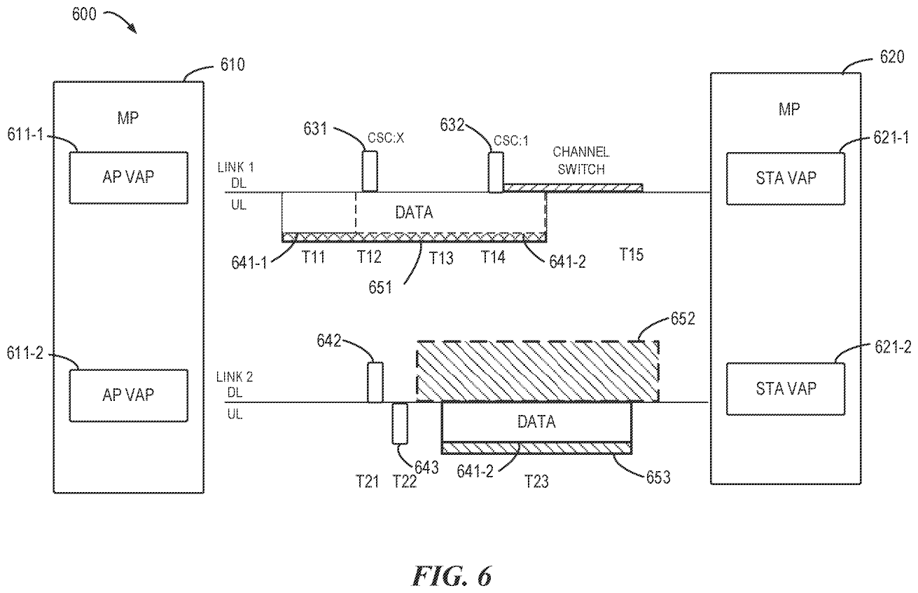

FIG. 6 illustrates an example procedure 600 of opportunity sharing during channel switching initiated by an MP in accordance with some example implementations of the present disclosure. As illustrated in FIG. 6, the MP 610 is provisioned with two AP VAPs, including an AP VAP 611-1 and an AP VAP 611-2. Accordingly, a downstream MP 620 is provisioned with two STA VAPs, including an STA VAP 621-1 and an STA VAP 621-2. A link 1 is established between the AP VAP 611-1 and the STA VAP 621-1. A link 2 is established between the AP VAP 611-2 and the STA VAP 621-2.

In the illustrated implementation, the MP 620 gains a TXOP 651 on the link 1 and transmits one part 641-1 of the data 641 within the TXOP 651. However, the MP 610 determines that the link 1 needs to be switched and transmits a beacon frame 631 with a CSC value of X at time point T12. The transmission of the other part of the data 641, which was supposed to be transmitted at time point T13 on the link 1, is stopped due to the CSA procedure. Later, the MP 610 gains a TXOP 652 on the link 2. In order to facilitate the transmission of the data buffered at the MP 620, the MP 610 transmits a multiple user-request to send (MU-RTS) TXOP Sharing (TXS) Trigger frame 642 to the MP 620 on the link 2 at time point T21 to share the TXOP 652 with the MP 620. Upon receipt of the MU-RTS TXS trigger frame, the MP 620 transmits a response 643 to the trigger frame at time point T22. Then, the MP 620 transmits the other part 641-2 of the data 641 at time point T23 with the TXOP 653 shared from TXOP 652. With this implementation, the traffic can be guaranteed to be transmitted successfully in a certain short time before or after the CSA link is “out of service.”

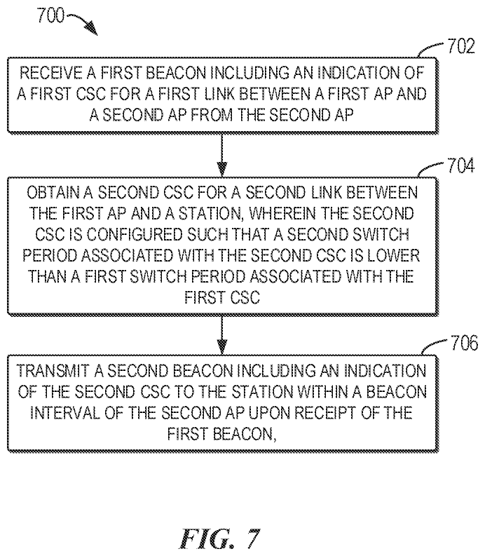

FIG. 7 illustrates a flowchart of an example method 700 of parallel channel switching in accordance with some example implementations of the present disclosure. For the purpose of discussion, the method 700 will be described with reference to FIG. 1. It would be appreciated that although the method 700 has been described as referring to the network environment 100 of FIG. 1, this method 700 may be likewise applied to other similar communication scenarios. For example, the method 700 may be implemented by the MP 120 in FIG. 1. While only some blocks are illustrated in the method 700, the method 700 may comprise other blocks described herein.

At 702, a first AP receives a first beacon, including an indication of a first channel switch count (CSC) for a first link between the first AP and a second AP from the second AP. For example, the MP 120 of FIG. 1 may receive a first beacon from the MPP 110. In this case, the first beacon includes an indication of a first CSC for the link 1-1 between the MP 120 and the MPP 110. The first CSC may function as an announcement to inform the MPs about a channel switching procedure and further indicate after how many TBTTs the AP switches to a new channel. In some example implementations, the first switch period may be determined based on the first CSC, and a first TBTT and the second switch period is determined based on the second CSC and a second TBTT.

At 704, the first AP obtains a second CSC for a second link between the first AP and a station. In this case, the second CSC is configured such that a second switch period associated with the second CSC is lower than a first switch period associated with the first CSC. In some example implementations, the station may be another MP downstream of the first AP. The station may also be an STA VAP.

For example, the MP 120 may obtain a second CSC for the link 1-2 between the MP 120 and the STA 130. In some example implementations, the second CSC may be determined by the central access controller 140. The central access controller 140 may receive management frames from all the APs in the mesh network and determine the CSC based on the operating states of the APs so that the second switch period associated with the second CSC is lower than the first switch period associated with the first CSC. In some alternative implementations, the second CSC may be determined by the first AP.

At 706, the first AP transmits a second beacon, including an indication of the second CSC to the station and within a beacon interval of the second AP upon receipt of the first beacon. For example, the MP 120 may transmit a second beacon to the MP 130 within a beacon interval of the MPP 110 upon receipt of the first beacon. With these implementations, the second CSC is determined so that the duration of a CSA procedure for the second link is shorter than the CSA procedure for the first link. In the meantime, the second beacon as an announcement for the channel switching for the second link is transmitted right after a channel switching indication beacon is received as soon as possible. As such, the CSA procedure for the second link will be complete no later than the CSA procedure for the first link. Therefore, a parallel channel switching can be achieved. The idle time period on the wireless interface is kept to the minimum, thereby reducing latency caused by the channel switching procedure and avoiding traffic interruption.

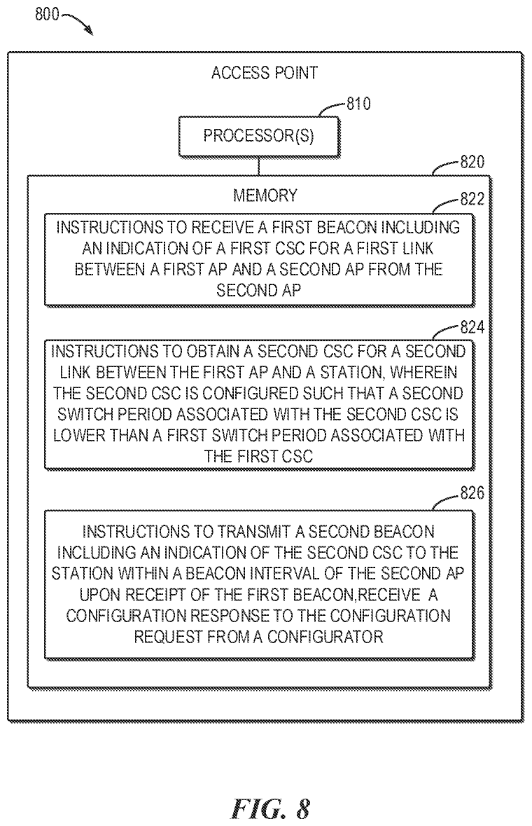

FIG. 8 illustrates a block diagram of an example AP 800 in accordance with some example implementations of the present disclosure. The AP 800 comprises at least one processor 810 and a memory 820 coupled to at least one processor 810. The memory 820 stores instructions to cause at least one processor 810 to implement actions.

As illustrated in FIG. 8, the memory 820 stores instructions 822 to receive a first beacon, including an indication of a first channel switch count (CSC) for a first link between the first AP and a second AP from the second AP. The memory 820 further stores instructions 824 to the first AP to obtain a second CSC for a second link between the first AP and a station. In this case, the second CSC is configured such that a second switch period associated with the second CSC is lower than a first switch period associated with the first CSC. The memory 820 further stores instructions 826 to transmit a second beacon, including an indication of the second CSC to the station and within a beacon interval of the second AP upon receipt of the first beacon.

The present disclosure also provides at least one computer program product tangibly stored on a non-transitory computer-readable storage medium. The computer program product includes program codes or instructions which can be executed to carry out the method as described above with reference to FIG. 7 and procedures as described above with reference to FIGS. 2-6.

While the above discussion used a Wi-Fi communication standard as an illustrative example, in other implementations, a wide variety of communication standards and, more generally, wireless communication technologies may be used. Furthermore, while some of the operations in the foregoing implementations were implemented in hardware or software, in general, the operations in the preceding implementations can be implemented in a wide variety of configurations and architectures. Therefore, some or all of the operations in the foregoing implementations may be performed in hardware, software, or both.

It should be noted that specific terms disclosed in the present disclosure are proposed for convenience of description, and a better understanding of example implementations of the present disclosure, and the use of these specific terms may be changed to another format within the technical scope or spirit of the present disclosure.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a computer-readable medium may be any tangible medium that may contain or store a program for use by or in connection with an instruction execution system, apparatus, or device. The computer-readable medium may be a computer-readable signal medium or a computer-readable storage medium. A computer-readable medium may include but is not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order illustrated or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is illustrated by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
receiving, by a first access point (AP) and from a second AP, a first beacon including an indication of a first channel switch count (CSC) for a first link between the first AP and the second AP;
obtaining, by the first AP, a second CSC for a second link between the first AP and a station, wherein the second CSC is configured such that a second switch period associated with the second CSC is lower than a first switch period associated with the first CSC; and
transmitting, by the first AP and to the station and within a beacon interval of the second AP upon receipt of the first beacon, a second beacon including an indication of the second CSC.

2. The method of claim 1, wherein the first switch period is determined based on the first CSC and a first target beacon transmission time (TBTT), and the second switch period is determined based on the second CSC and a second TBTT.

3. The method of claim 2, wherein the second TBTT is configured such that a first listen time period including a first number of intervals of the first TBTT is shorter than or equal to a second listen time period including a second number of intervals of the second TBTT.

4. The method of claim 1, wherein transmitting the second beacon comprises:
obtaining, by the first AP, an indication of a time offset between a first time of receipt of the first beacon and a second time of transmission of the second beacon, the time offset being greater than or equal to a transmission time period associated with traffic between the first AP and the second AP, and being smaller than or equal to the second interval of the second TBTT; and
transmitting, by the first AP and to the station at the second time, the second beacon.

5. The method of claim 1, further comprising:
determining, by the first AP, a channel switch for the second link between the first AP and the station;
transmitting, by the first AP and to the station, a first traffic mapping request indicating a re-allocation of traffic mapped to the second link to at least one further link between the first AP and the station during the channel switch; and
receiving, by the first AP and from the station, a first traffic mapping response to the traffic mapping request.

6. The method of claim 5, further comprising:
in response to determining that the channel switch is complete, transmitting, by the first AP and to the station, a second traffic mapping request indicating a re-allocation of traffic between the first AP and the station to a new second link and the at least one further link; and
receiving, by the first AP and from the station, a second traffic mapping response to the second traffic mapping request.

7. The method of claim 5, further comprising:
obtaining, by the first AP, a transmission opportunity (TXOP) on the at least one further link during the channel switch;
transmitting, by the first AP and to the station, a transmission trigger frame indicating an allocation of a transmission time period for the station within the transmission opportunity on the at least one further link; and
receiving, by the first AP and from the station, a transmission determination frame corresponding to the transmission trigger frame.

8. The method of claim 7, further comprising:
receiving, by the AP and from the station, traffic mapped to the first link on both the first link and the at least one further link during the transmission time period.

9. The method of claim 5, further comprising:
receiving, by the first AP and from the second AP on a third link between the first AP and the second AP, a first action frame including the indication of the first CSC and an indication of a new channel for the first link; and
transmitting, by the first AP and to the station, a second action frame on a fourth link between the first AP and the station, a channel of the fourth link being same as a channel of the third link.

10. The method of claim 9, wherein the indication of the first CSC is included in a beacon frame of the second AP, and wherein the beacon frame and the action frame are transmitted simultaneously.

11. The method of claim 9, further comprising:
establishing, by the first AP, a new first link on the new channel between the first AP and the second AP based on the indication of the new channel.

12. The method of claim 1, further comprising:
in response to determining that a channel of the second link needs to be switched, determining, by the first AP, a channel switch for the second link; and
transmitting, by the first AP and to the second AP, a channel switch request and an indication to terminate a transmission from the second AP to the first AP.

13. The method of claim 12, further comprising:
detecting, by the first AP, an external signal on a first channel;
determining, by the first AP, that the first channel is the same as the channel of the second link; and
determining, by the first AP, that the channel of the second link needs to be switched.

14. An access point (AP) comprising:
at least one processor; and
a memory coupled to the at least one processor, the memory storing instructions to cause the at least one processor to:
receive, from a further AP, a first beacon including an indication of a first channel switch count (CSC) for a first link between the AP and the further AP;
obtain a second CSC for a second link between the AP and a station, wherein the second CSC is configured such that a second switch period associated with the second CSC is lower than a first switch period associated with the first CSC; and
transmit, within a beacon interval of the further AP upon receipt of the first beacon, a second beacon including an indication of the second CSC to the station.

15. The AP of claim 14, wherein the first switch period is determined based on the first CSC and a first target beacon transmission time (TBTT) and the second switch period is determined based on the second CSC and a second TBTT.

16. The AP of claim 15, wherein the second TBTT is configured such that a first listen time period including a first number of intervals of the first TBTT is shorter than or equal to a second listen time period including a second number of intervals of the second TBTT.

17. The AP of claim 14, wherein instructions to cause the at least one processor to transmit the second beacon comprises instructions to cause the at least one processor to:
obtain an indication of a time offset between a first time of receipt of the first beacon and a second time of transmission of the second beacon, the time offset being greater than or equal to a transmission time period associated with traffic between the AP and the further AP, and being smaller than or equal to the second interval of the second TBTT; and
transmit the second beacon to the station at the second time.

18. The AP of claim 14, wherein the at least one processor is further caused to:
determine a channel switch for the second link between the AP and the station;
transmit, to the station, a first traffic mapping request indicating a re-allocation of traffic mapped to the second link to at least one further link between the AP and the station during the channel switch; and
receiving a first traffic mapping response to the traffic mapping request from the station.

19. The AP of claim 18, further comprising:
in response to determining that the channel switch is complete, transmitting, to the station, a second traffic mapping request indicating a re-allocation of traffic between the AP and the station to a new second link and the at least one further link; and
receiving a second traffic mapping response to the second traffic mapping request from the station.

20. A non-transitory computer-readable medium comprising instructions stored thereon which, when executed by an access point (AP), cause the AP to:
receive, from a further AP, a first beacon including an indication of a first channel switch count (CSC) for a first link between the AP and the further AP;
obtain a second CSC for a second link between the AP and a station, wherein the second CSC is configured such that a second switch period associated with the second CSC is lower than a first switch period associated with the first CSC; and
transmit, within a beacon interval of the further AP upon receipt of the first beacon, a second beacon including an indication of the second CSC to the station.
